(19) United States
(12) Patent Application Publication
(10) Pub. No.: US 2004/0038009 A1
(43) Pub. Date: Feb. 26, 2004

(54) Water-based material systems and methods for 3D printing

(76) Inventors: Richard Noel Leyden, Topanga, CA (US); Timothy Marvin Cleary, Sherman Oaks, CA (US); John Xiaosan Li, Alhambra, CA (US); Jacek Obuchowicz, South Cambridgeshire (GB); Richard J. Peace, Bedford (GB)

Correspondence Address: PROSKAUER ROSE LLP, PATENT DEPARTMENT, 1585 BROADWAY, NEW YORK, NY, 10036-8299, US

(21) Appl. No.: 10/225,830

(22) Filed: Aug. 21, 2002

(51) Int. Cl. B32B 3/00

(52) U.S. Cl. 428/195.1; 428/206

(57) ABSTRACT

The present invention provides unique material systems and methods for 3D printing of articles having enhanced strength and durability. The powder systems comprise a water-soluble crosslinkable agent, and alternatively or additionally, a strengthening component. Preferably, the crosslinkable agent is selected from the group consisting of amino resins, phenol resins, and mixed amino/phenol resins. The strengthening component melts and flows when heated, and resolidifies or cures. Preferably, the strengthening component melts, flows and cures with heat.

In another aspect, the invention provides a powder/binder system comprising an oxidant and a reductant (a redox couple). When the binder is applied to the powder, the oxidant and reductant react to generate an acid that catalyzes crosslinking. As a result, the strength of the 3D article builds up at an enhanced rate. The oxidant may be in the powder, and the reductant in the binder; or the reductant may be in the powder, and the oxidant in the binder. Alternatively, both the oxidant and the reductant may be in the powder.

### FIELD OF THE INVENTION

This invention relates generally to the field of rapid prototyping, and more particularly to three-dimensional (3D) printing materials, methods and articles made therefrom.

### BACKGROUND

Rapid Prototyping techniques translate three-dimensional digital design files into physical objects. In stereolithography, CAD files are translated into 3D objects by selective laser irradiation and curing of successive layers of liquid photopolymer. See, e.g., U.S. Pat. No. 4,575,330 (Hull). However, stereolithographic equipment is expensive and is operable only by trained experts.

3D inkjet printing equipment is much less expensive and lends itself to being operable in an office environment. Early 3D printing materials and methods are described in U.S. Pat. Nos. 5,204,055 (Sachs et al.), 5,340,656 (Sachs et al.), and 5,807,437 (Sachs et al.). In 3D printing, a liquid binder is selectively applied (e.g., using an inkjet printhead) to successive layers of powder. Upon contact with the powder, the liquid adhesively bonds the powder into a solidified layer, and also bonds each layer to the previous layer. Typical organic binder materials are polymeric resins, or ceramic precursors. The available powder materials are either starch/cellulose based or plaster based powders (e.g. ZP-11, ZP-14, ZP-100, and ZP-102 by Z Corporation, Burlington, Mass.).

As a reflection of the materials from which they are built, current 3D printed articles are delicate and easily damaged. Such articles often require post-printing strengthening treatments, e.g. infiltration or coating with a hardenable material such wax, lacquer, cyanoacrylate, or urethane. Accordingly, there remains a need for powders and binders that can be used to create 3D inkjet-printed articles having increased strength and durability, while remaining safe for use in an office environment.

### SUMMARY OF THE INVENTION

The present invention fulfills that need by providing curable, water-based material systems and methods for use with 3D printers. The material systems comprise a solid powder system and an aqueous liquid binder. The powder system comprises a water-soluble crosslinkable agent, and alternatively or additionally, a strengthening component. Preferably, the crosslinkable agent is selected from the group consisting of amino resins, phenol resins, and mixed amino/phenol resins. The strengthening component melts and flows when heated, and resolidifies or cures. Preferably, this component melts, flows and cures with heat.

In another aspect, the invention provides a powder/binder system comprising an oxidant and a reductant (a redox couple). When the binder is applied to the powder, the oxidant and reductant react to generate an acid that catalyzes the polymerization and crosslinking reactions. As a result, strength development is enhanced. The oxidant may be in the powder, and the reductant in the binder; or the reductant may be in the powder, and the oxidant in the binder. Alternatively, both the oxidant and the reductant may be in the powder.

There is also provided a method for printing a 3D article on a 3D printing apparatus, wherein any of the powder compositions disclosed herein may be used to form a first layer of powder, onto which is dispensed an aqueous binder fluid in a predetermined, cross-sectional pattern. Upon contact, the aqueous binder dissolves the soluble components of the powder system, which may include the crosslinkable agent, and transforms the powder within the imaged area into an essentially solid layer. The above-described steps of forming a powder layer and dispensing aqueous binder in a predetermined pattern are repeated, each new layer adhering to the layer below, until the 3D article achieves its final shape.

The material systems and methods of this invention may be used in a conventional 3D printer to create a 3D article having improved strength and durability over 3D articles printed from conventional starch/cellulose or plaster powders and aqueous binders.

### DETAILED DESCRIPTION OF THE INVENTION

This invention is concerned with 3D printing methods that involve the use of powders and liquid binders. Other 3D printing methods do not use powders, but instead form a 3D article by jetting successive layers of liquid resin in a predetermined pattern, and then curing layer-by-layer with actinic radiation or heat.

The 3D printing method of this invention involves the formation of a powder layer from any of the powder systems disclosed herein, onto which is dispensed an aqueous binder fluid in a predetermined, cross-sectional pattern. Upon contact, the aqueous binder dissolves the active components of the powder system, which may include particulate adhesive material and/or the crosslinkable agent described below, and transforms the powder to an essentially solid layer. The above-described steps of forming a powder layer and dispensing aqueous binder in a predetermined pattern are repeated, each new layer adhering to the layer below, until the 3D article achieves its final shape.

Any portion of the powder system that was not exposed to the fluid remains loose and free flowing within the build space of the printer. Ideally, the unbound powder is left in place until the 3D article is fully formed, which ensures that the article is supported during printing, allowing cantilevered regions and cavities within the article to be built without support structures.

Once the article has achieved its final shape, unreacted powder may be removed from the article by blown air or a vacuum. Post-processing treatments may be performed on the article, e.g. heat curing (to further strengthen the article), cleaning, painting, or other surface treatments.

The powder systems of this invention may comprise one or more of the following ingredients.

### The Powder System

### Crosslinkable Agents

A “crosslinkable agent” is a monomer, oligomer, polymer, or polymer mixture that has functional groups capable of forming covalent bonds (crosslinks), either with itself or with the functional groups of other crosslinkable agents. Preferably, the crosslinkable agent is selected from the group consisting of amino resins, phenol resins, and mixed amino/phenol resins. Amino resins, phenol resins, and mixed amino/phenol resins are derived from the reaction of formaldehyde and an amine, a phenol, or a mixture of an amine and a phenol, respectively. Most preferably, crosslinkable agents are selected from the group consisting of melamine-formaldehyde resins, urea-formaldehyde resins, melamine-urea-formaldehyde resins, melamine-phenol-formaldehyde resins, benzoguanamine-formaldehyde resins, glycoluril-formaldehyde resins, and acetoguanamine-formaldehyde resins. Additionally, the crosslinkable agent may be a glyoxal resin or a methylol carbamate.

The powder system may comprise from about 1% to about 60% by weight of a crosslinkable agent in powder form. The size of the particles should be less than the thickness of the layers to be printed. The shape of the particles may be regular or irregular.

When a standard aqueous binder is applied to a powder system comprising a crosslinkable agent, the crosslinkable agent dissolves and may begin to polymerize and crosslink with itself and other water soluble functional resins, thereby contributing structure and strength to the printed article. The crosslinking occurs within the layer being formed, as well as with previously formed layers. In order to achieve these results, the crosslinkable agent should be soluble in water at room temperature. Preferably, the agent will a) be crosslinkable under ambient conditions; b) have the ability to catalyze in moderately acidic solutions; and c) have a relatively rapid cure rate.

Thin films of the crosslinkable agent may be coated onto a filler material such as glass spheres, flakes or fibers, and used in this form in the powder systems described herein. In this embodiment, lower volumes of binder fluid are required to solubilize the crosslinkable agent. The time required for the solubilized agent to fully penetrate the agent on the other surface treated particles is reduced, and consequently, green strength development and final strength development are enhanced. This embodiment also helps to reduce the spread of fluid into non-image areas.

Acid catalysts may be used to accelerate crosslinking of the crosslinkable agent, and these include, e.g., lewis acids (such as ammonium chloride, tin (II) chloride, magnesium chloride, cobalt, sulfate, or iron III chloride), which may be incorporated into the powder (but tend to reduce storage stability). Acid catalysts may also include, e.g., blocked acid catalysts such as Nacure (King Industries, Norwalk, Connecticut), which release acid upon heating and can be incorporated into the powder, binder, or redox systems herein described.

### The Strengthening Component

In another aspect of this invention, the powder system contains a “strengthening component” that melts and flows upon heating, then resolidifies on cooling, or preferably thermal cures. The powder to which the strengthening component is added can be any powder suitable for 3D printing, such as a standard starch/cellulose or plaster powder, and the crosslinkable agent-containing powder systems described above. Preferably, the strengthening component is substantially inert when contacted with an aqueous binder at ambient temperature. In other words, when the 3D article is initially printed, the strengthening component does not contribute substantially to the article's strength. However, when the article is heated, e.g., in an oven, the strengthening component melts and flows within the article, filling gaps and pores and engulfing other components of the powder, and then it resolidifies or cures, which adds substantially to the strength of the 3D article.

Preferably, the strengthening component reacts to produce a thermoset polymer when it is heated. By way of example, the strengthening component may comprise a blend of an epoxy resin and a carboxyl group-containing polyester (such as those used in powder coating applications, e.g. U.S. Pat. No. 6,117,952), which reacts when heated to produce a thermoset polymer.

A powder system containing a strengthening component further may further comprise a crosslinkable agent, as described above.

### Other Additives

One of skill in the art will appreciate that the powder systems of this invention may contain other ingredients such as adhesives, fillers, cohesive aids, thickeners, and polyols, which improve the material system's performance in 3D printers, and provide desired mechanical properties in the printed article.

Adhesives suitable for the material systems of this invention should be water soluble at room temperature, so that the adhesive is activated when contacted by the aqueous binder fluid. Examples include polyvinyl alcohol and poly(ethyloxazoline). In general, the adhesive should be milled; preferably to less than 100 microns, and more preferably in the range of 20-40 microns. In any event, the adhesive powder should be fine enough to enhance dissolution in the aqueous binder, without being so fine as to cause “caking”, an undesirable phenomenon wherein unactivated powder adheres to the printed article, resulting in poor resolution. The powder systems of this invention may contain 0% to about 90% by weight of one or more adhesives.

Fillers suitable for the material systems of this invention should be insoluble, or only slightly soluble, in the aqueous binder fluid, should be readily wettable, should be capable of adhesively bonding with the adhesive components of the powder system; may be coated (e.g., with aminosilanes) or uncoated; and should not render the powder system unspreadable. Examples of suitable fillers, which may be used alone or in combination, include glass spheres, flakes or fibers; inorganic mineral fillers (such as wollastonite or mica); clay fillers (such as Kaolin); starches (such as maltodextrin); plaster; polymeric fibers (such as cellulose fiber); ceramic fiber; graphite fiber; limestone; gypsum; aluminum oxide; aluminum silicate; potassium aluminum silicate; calcium silicate; calcium hydroxide; calcium aluminate; sodium silicate; metals; metal oxides (such as zinc oxide, titanium dioxide and magnetite); carbides (such as silicon carbide); borides (such as titanium diboride); and inert polymers such as polymethylmethacrylate, polysterene, polyamide and polyvinyl chloride.

The filler component may include a variety of particle sizes, ranging from about 5 microns up to about 200 microns. Generally speaking, the mean size of the particulate material cannot be larger than the layer thickness. Large particle sizes may improve the quality of the printed article by forming large pores in the powder through which the binder fluid can easily migrate. Smaller particle sizes may serve to reinforce article strength. A distribution of particle sizes may be particularly desireable, as it may increase the packing density of the particulate material, which in turn may increase both article strength and dimensional control. Ideally, the powder systems of this invention may contain from about 0% to about 60% by weight of a main filler (such as glass spheres), and from about 0% to about 30% by weight of one or more other fillers (such as inorganic mineral fillers and/or clay fillers). Solid glass spheres are preferred as the main fillers, because they are readily wetted by liquid components of the composition (e.g. surfactants and wetting agents).

Cohesive aids provide light adhesion between the powder grains, thereby reducing dust formation and promoting even spreading of the powder. Examples include polyethylene glycol, sorbitan trioleate, citronellol, ethylene glycol octanoiate, ethylene glycol decanoiate, ethoxylated derivatives of 2,4,7,9-tetramthyl-5-decyn-4,7-diol, sorbitan mono-oleate, sorbitan mono-laurate, polyoxyethylene sorbitan mono-oleate, soybean oil, mineral oil, propylene glycol, fluroalkyl polyoxyethylene polymers, glycerol triacetate, oleyl alcohol, and oleic acid. The powder systems of this invention may contain 0% to about 10% by weight of one or more cohesive aids.

Thickeners work to increase the viscosity of the fluid binder, thus minimizing the diffusion of the binder into the surrounding powder. It is believed that thixotropic agents such as CARBOPOL® EZ-2 (polyacrylic acid from Noveon, Inc., Cleveland, Ohio), when added to the powder system, will mediate the settling of fine, denser filler materials during the initial stage of binder migration. Furthermore, the swelling of the EZ-2 polymer may counteract to some degree the natural tendency of the amino resins to shrink upon curing. Finally, the acidic character of EZ-2 is believed to catalytically assist the polymerization of the crosslinkable agent. The material systems of this invention may contain about 0% to about 15% by weight of one or more thickeners.

Surfactants increase the solubility in the aqueous binder of lipophilic powder components. Surfactants may be present in the binder system and/or in the powder system. For example, the powder system may contain up to about 6% of one or more surfactants. Examples of surfactants include perfluoroalkyl polyethers.

The powder system may comprise a polyol to increase the extent of crosslinking of the crosslinkable agent. Examples of polyols include tetramethylol methane, glycerol, sorbitol, erythritol, polyvinyl alcohol and trimethylolpropane. The powder systems of this invention may contain from 0% to about 90% by weight of one or more polyols.

### The Aqueous Binder System

The aqueous binder system is selected to provide the degree of solubility required for the various powder components described above. Powder systems of this invention are compatible with standard aqueous binders, such as ZB-7 (Z Corporation). The binder system of this invention comprises mainly water, but may comprise other additives known to those of skill in the art, such as surfactants, humectants, water absorbing moieties, and dyes.

### The Redox Couple

Another aspect of this invention is a powder/binder system that comprises an oxidant and a reductant, which react to generate an acid when the binder is applied to the powder. The oxidant may be in the powder, and the reductant in the binder; or the reductant may be in the powder, and the oxidant in the binder. Alternatively, both the oxidant and the reductant may be in the powder.

The oxidant is preferably an inorganic oxidant, such as ammonium persulfate, sodium persulfate, potassium persulfate, and ceric ammonium nitrate.

The reductant is preferably an inorganic reductant, such as sodium sulfite, ascorbic acid, sodium hydrogen sulfite, and sodium metabisulfite.

The material system to which the oxidant or reductant is optionally added may be any aqueous powder/binder system suitable for 3D printing that is acid sensitive. For example, in a particularly preferred embodiment, the powder comprises the crosslinkable agent described above.

A benefit of this approach is that acid catalysis is achieved without using corrosive acids in the binder or powder. When acids are incorporated into the binder, they often cause the printhead to clog. Moreover, when even weak acid precursors like ammonium chloride are included in the powder, the powders become less storage stable, especially in humid conditions. And there are relatively few solid acids suitable for use in 3D printable powders. Consequently, this aspect of the present invention increases the selection of potential acid catalysts, and provides storage stable powders and printhead-friendly binders.

In another embodiment of the invention, a component is added to the binder and/or to the powder to catalyze the reaction of the oxidant with the reductant, thus accelerating the production of acid. Preferably, the component is a metal ion catalyst, such as copper sulfate, cobalt sulfate, copper (II) salts, iron (II) salts, and silver (I) salts.

The material system containing a crosslinkable agent and a strengthening component may further include an oxidant and a reductant. In these embodiments, the 3D article will have good green strength due to the crosslinkable agent (catalyzed by the acid generating oxidant and reductant), and improved heat-cured strength due to the crosslinkable agent and the strengthening component.

A representative powder system within the scope of this invention comprises:

a) about 10% to about 60% by weight of an amino resin, a phenol resin, or a mixed amino/phenol resin;

b) about 2% to about 60% by weight of a filler such as glass spheres;

c) 0% to about 30% of an adhesive such as polyvinyl alcohol (e.g. AIRVOL® 502 by Air Products and Chemicals, Inc.) or polyethyl oxazoline (e.g. AQUAZOL® by Polymer Chemistry Innovations);

d) 0% to about 30% by weight of Wollastonite (a fibrous inorganic mineral filler by NYCO Minerals Inc.);

e) 0% to about 30% by weight of an inorganic mineral filler such as mica (Franklin Industrial Minerals);

f) 0% to about 30% by weight of a Kaolin clay filler (by K-T Clay Co.);

g) 0% to about 15% by weight of an inorganic oxidant such as ammonium persulfate;

h) 0% to about 15% by weight of a thickener such as CARBOPOL EZ-2;

i) 0% to about 10% by weight of other customary additives, at least one of which is an oil such as SPAN 85 (sorbitan trioleate); and

j) 0% to about 6% by weight of another customary additive such as LODYNE® 222N (a perfluoroalkyl polether by Ciba Specialty Chemicals, Inc.), or similar surfactant.

Fillers b), d), e), and f) may be coated or uncoated.

A representative liquid binder comprises:

a) 0% to about 25% by weight of an inorganic reductant such as sodium sulfite;

b) 0% to about 6% by weight of a wetting agent such as LODYNE 222N; and

c) about 20% to about 99% by weight of de-ionized water.

### 3D Articles

The material systems of this invention may be used with a conventional 3D printer to create 3D articles having improved strength. By way of illustration, rectangular test bars (5.0 mm width×5.5 mm height×50 mm length) may be built on a Z402 3D inkjet printer (Z Corporation) and tested on a 3-point bending apparatus to measure “as-printed” flexural strength (i.e. green strength). Similarly, test bars may be printed, heat cured, and then tested to measure post-cure flexural strength. The ability of a material to resist deformation under a load is its flexural strength.

The “as-printed” flexural strength of an article, such as a test bar, is the flexural strength that exists shortly after build, and before any post-print strengthening operations have been performed on the article (such as heating, infiltration, or irradiation). As-printed flexural strength is calculated by the equation:

σ=3Px/t²W

wherein P is the load in N; x is one half the distance between the vertical supports in mm; t is bar thickness in mm; and w is the bar width in mm. The units are MPa.

It is possible to achieve as-printed flexural strengths of greater than 10 MPa in 3D articles made from material systems containing the crosslinkable agent of this invention, which is higher than analogous 3D articles made with conventional starch/cellulose based or plaster based powder systems such as ZP-11 and ZP-100. More preferably, it is possible to achieve as-printed flexural strengths of at least about 20 MPa in 3D articles made from material systems containing the crosslinkable agent of this invention.

To increase even further the strength of the printed article, the article may be heated. The crosslinkable agent cures rapidly when heated, resulting in a rapid increase in article strength. By way of example, when a test bar is cured for just 30 minutes at 120° C., its flexural strength is preferably at least about 20 MPa. More preferably, the bar's flexural strength after curing for 30 minutes at 120° C. is at least about 30 MPa. Still more preferably, the bar's flexural strength after curing for 30 minutes at 120° C. is at least about 40 MPa. Most preferably, the bar's flexural strength after curing for 30 minutes at 120° C. is at least about 50 MPa.

3D articles printed from conventional starch/cellulose or plaster powders containing a strengthening component preferably have a flexural strength of at least about 2.25 MPa after curing for 45 minutes at 120° C. More preferably, articles printed from such systems have a flexural strength of at least about 2.75 MPa after curing for 45 minutes at 120° C. When the article is cured for 45 minutes at 180° C., it preferably has a flexural strength of at least about 3.5 MPa; and more preferably, at least about 5.0 MPa.

After heat curing, a 3D article formed from a conventional starch/cellulose or plaster powder comprising a strengthening component is stronger than a 3D article formed from a conventional powder that does not contain a strengthening component. Preferably, after curing the article for 45 minutes at 120° C., the article will have a flexural strength that is at least about 20%, and preferably about 50% higher than the flexural strength of a similar article created and cured under the same conditions using an otherwise identical powder that does not contain the strengthening component.

A 3D article prepared from a powder system containing a crosslinkable agent and a strengthening component will be at least 4 times stronger after curing at 120° C. for 45 minutes than an analogous article made from an equivalent amount of plaster powder having no crosslinkable agent or strengthening component

Those skilled in the art will readily appreciate that the experimental details set forth below are meant to be exemplary, and that actual parameters depend upon the specific application for which the methods and material systems of the invention are used. Consequently, it is intended that the foregoing embodiments are presented by way of example only and that, within the scope of the patent claims and equivalents thereto, the invention can be practiced otherwise than as specifically described below.

### EXAMPLE

### Preparation of Powder Compositions Comprising Crosslinkable Agents

Powder systems having the compositions set forth in Table 1 were prepared according to the following protocol.

1. Pre-Mixing

All “oils” (i.e. oils, surfactants and wetting agents) were combined and mixed well in a small beaker. To this liquid was added an amount of the main (nonfunctional) filler to give a ratio of at least 5 parts to 1 part, filler to liquid. The liquid and filler were mixed with a spatula until a homogenous paste was formed. A mixer or spray drier may also be used. The resulting paste was added to the remainder of the main filler and vigorously mixed to form a thick, homogenous paste that was easy to work with.

2. Mixing

The thick paste was transferred to the mixing bowl of a food mixer (of the type designed to mix bread dough) into which was combined the remaining fillers, mixing thoroughly for about 30 seconds. All of the blades supplied with the mixer ought to be tried to determine which provides the most efficient mixing. The powdered additives of the composition were added next, and mixed for about 30 seconds. Finally, all of the resin was added and mixed for 5 to 10 minutes. The speed of the mixer was set as high as possible so as to ensure good mixing, but not so high that material was propelled from the bowl. Alternatively, a planetary mixer or a ribbon blender may be used for this mixing step, and mixing times may extend to one hour.

3. Sieving

Using a sieve of about 500 μm, the mixed powder was sieved to remove any large particles or agglomerates. After sieving, the coarse particles were discarded. The resulting powder was then mixed for an additional minute or two to ensure that the sieving process didn't produce a layering effect in the powder.

The finished powder had a floury texture and displayed an adequate degree of particle cohesion. Cohesion was tested by taking a handful of the powder and squeezing firmly. The powder formed a solid lump in the hand, indicating that there was adequate particle cohesion, and a sufficient amount of “oils” in the formulation.

TABLE 1
Powder Compositions (in weight percents)

| | A | B | C | D | E | F | G | H | I | J | K | L | M |
|---|---|---|---|---|---|---|---|---|---|---|---|---|---|
| Filler | | | | | | | | | | | | | |
| SPHERIGLASS ® | | | | | | | | | | 31.8 | 29.9 | 30.6 | 30.1 |
| 3000E | | | | | | | | | | | | | |
| SPHERIGLASS ® | 50.30 | | | | | | | | | | | | |
| 3000E-CP-03^{a} | | | | | | | | | | | | | |
| SPHERIGLASS ® | | | 3.00 | 4.60 | 4.00 | 4.00 | 4.80 | 3.00 | 2.00 | | | | |
| 3000E-CP-03^{b} | | | | | | | | | | | | | |
| SPHERIGLASS ® | | 30.10 | 30.10 | 31.00 | 30.00 | 30.00 | 33.00 | 30.00 | 35.00 | | | | |
| 2530E-CP-03^{c} | | | | | | | | | | | | | |
| NYAD 200^{d} | | 17.00 | 14.00 | | 8.00 | 8.00 | | 9.00 | | 20 | 18.8 | 19.3 | 18.9 |
| NYAD G^{e} | | | | | | | | 2.70 | | | | | |
| NYAD Wollastocoat 400 | | | | | | | | | 5.00 | | | | |
| 10012^{f} | | | | | | | | | | | | | |
| Amlok 321^{g} | | 5.00 | 5.00 | 9.00 | 7.00 | 7.00 | 7.00 | 4.50 | 4.00 | | | | |
| K-T Diamond^{h} | | | | 6.00 | | | | | | | | | |
| K-T Rogersⁱ | | | | | 3.00 | | | | | | | | |
| Mica C-3000^{j} | | | | | | 3.00 | 7.00 | 2.50 | | | | | |
| Crosslinkable Agents | | | | | | | | | | | | | |
| UFP 1001^{k} | 36.00 | | | | | | | | | | | | |
| MF-817^{l} | | 40.00 | 40.00 | 40.00 | 40.00 | 40.00 | 40.00 | 40.00 | 46.00 | 40 | 37.6 | 38.5 | 37.8 |
| Adhesives | | | | | | | | | | | | | |
| AIRVOL ® 502^{m} | 11.00 | | | | | | | 5.00 | 4.00 | 5.0 | 4.7 | 4.8 | 4.7 |
| AQUAZOL ®-50ⁿ | | 5.00 | 5.00 | 6.00 | 5.00 | 5.00 | 5.00 | | | | | | |
| Additives | | | | | | | | | | | | | |
| SPAN 85° | 0.05 | 0.30 | 0.30 | 0.30 | 0.30 | 0.30 | 0.30 | 0.30 | 0.30 | 0.30 | 0.28 | 0.29 | 0.28 |
| LODYNE ® S-107B^{p} | 0.15 | | | | | | | | | 0.90 | 0.85 | 0.87 | 0.85 |
| LODYNE ® S-222N^{q} | | 0.60 | 0.60 | 0.60 | 0.70 | 0.70 | 0.90 | 1.00 | 1.30 | | | | |
| Ammonium Chloride^{r} | 2.50 | | | | | | | | | | | | |
| Cobalt Sulfate | | | | | | | | | | | 6.0 | | |
| Hexahydrate | | | | | | | | | | | | | |
| Calcium Sulfate | | | | | | | | | | | | 3.7 | |
| Dihydrate | | | | | | | | | | | | | |
| Copper Sulfate | | | | | | | | | | | | | 5.5 |
| Pentahydrate | | | | | | | | | | | | | |
| CARBOPOL ® EZ-2^{s} | | 2.00 | 2.00 | 2.50 | 2.00 | 2.00 | 2.00 | 2.00 | 2.40 | 2.0 | 1.87 | 1.94 | 1.87 |
| Total | 100.0 | 100.0 | 100.0 | 100.0 | 100.0 | 100.0 | 100.0 | 100.0 | 100.0 | 100.0 | 100.0 | 100.0 | 100.0 |

^{a}Epoxy silane coated glass spheres from Potters Industries, Inc. (Valley Forge, PA)
^{b}Amino silane coated glass spheres from Potters Industries, Inc. (Valley Forge, PA)
^{c}Amino silane coated glass spheres from Potters Industries, Inc. (Valley Forge, PA)
^{d}Wollastonite, a calcium metasilicat mineral from NYCO Minerals (Willsboro, NY)
^{e}Wollastonite, a calcium metasilicat mineral from NYCO Minerals (Willsboro, NY)
^{f}Amino silane coated Wollastonite, Calcium metasilicat mineral from NYCO Minerals (Willsboro, NY)
^{g}Amino silane coated Kaolin clay from Kentucky-Tennessee Clay Co. (Mayfield, KY)
^{h}Kaolin clay from Kentucky-Tennessee Clay Co. (Mayfield, KY)
ⁱKaolin clay from Kentucky-Tennessee Clay Co. (Mayfield, KY)
^{j}Micronized Muscovite Mica from Darwin Chemical Co. (Ft. Lauderdale, FL)
^{k}Powdered urea/formaldehyde resin from SRA Intl. Ltd. (Port of Spain, Trinidad, West Indies)
^{l}Powdered melamine/formaldehyde resin from BTLSR Ltd. (Toledo, OH)
^{m}Polyvinyl alcohol from Air Products and Chemicals (Allentown, PA) (milled to <45 μm by Vortec Products, Long Beach, CA), or from Schenectady International, Inc. (Schenectady, NY) (milled to <80 microns using an air microniser).
ⁿPoly(ethyloxazoline) from Polymer Chemistry Innovations, Inc. (Tucson, AZ)) milled to <74 μm by Vortec Products (Long Beach, CA)
^{o}Sorbitan trioleate from Aldrich Chemical Co. (Milwaukee, WI)
^{p}Perfluoroalkyl polyether from Ciba Specialty Chemicals, Inc. (Tarrytown, NY)
^{q}Perfluoroalkyl polyether from Ciba Specialty Chemicals, Inc. (Tarrytown, NY)
^{r}The ammonium chloride may be ground to <80 microns using an air microniser
^{s}Polyacrylic acid from Noveon, Inc. (Cleveland, OH)

### EXAMPLE 2

### 3D Articles from Powder Compositions Comprising Crosslinkable Agents

Test bars were printed from each of the powder compositions appearing in Table 1 using a Z-402 3D printer from Z Corporation.

A standard aqueous binder (ZB-4 or ZB-7, from Z Corporation) was combined with powder compositions A-J. The binder for formulations K-M had the following composition: 17% ammonium hydrogen phosphate; 0.01% Lodyne S-222N; and 82.99% deionized water.

Test bars oriented in both the fast axis and slow axis directions were prepared by spreading successive layers of powder at a thickness of 0.1 mm and applying to each layer the applicable binder fluid at saturations of 1.25 external and 1.25 internal. The resulting bars (measuring 5.0×5.5×50 mm) remained in the powder bed until sufficient green strength had developed to permit handling (about 1 hour). The test bars were then dried in an oven at 40° C. for a minimum of 8 hours, and de-powdered with a de-powdering set-up (compressor, airbrush, and a 0.063 inch id×0.5 inch needle) operating at 40 psi and other standard conditions for blowing off parts. Some of the bars were thermal cured at 160° C. for 1-2 hours after the initial oven-drying step. Alternatively, the bars may be thermal cured at 120° C. for 30 minutes.

“As-printed” flexural strength values were measured after the test bars had been oven-dried and thoroughly de-powdered. The bars were mounted on a 3-point bending jig (available from Stable Mills Systems as a TA.XT2i texture analyzer set in a 3-point bend mode). The jig supports are separated by 40 mm, and the crosshead set to descend at a constant rate of 0.5 mm/second. The bars were mounted in the lamination plane vertical to eliminate top and bottom layer distortion. A varied load force was applied to the bar until it broke, at which point the “as-printed” flexural strength was read from the apparatus. Post-cure flexural strength values were measured in the same fashion, after the printed bars had been subjected to thermal curing under the conditions set forth above. The as-printed and post-cure flexural strength values are presented in Table 2.

TABLE 2
Flexural Strengths

| Powder | As-Printed Flexural | Flexural Strength after |
|---|---|---|
| Composition | Strength (MPa) | Heat Cure (MPa) |
| A | 21 | |
| B | 10 | 47 |
| C | 8 | 48 |
| D | 21 | 57 |
| E | 9 | 47 |
| F | 11 | 39 |
| G | 8 | 30 |
| H | 7 | 26 |
| I | 8 | 43 |
| J | 9 | |
| K | 11 | 14 |
| L | 12 | 14 |
| M | 12 | 16 |
| ZP-11 | 4 | 4 |
| | | (or lower) |
| ZP-100 | 10 | 10 |

When the powder comprises a crosslinkable polymer, the 3D-printed article has an “as-printed” flexural strength that exceeds the “as printed” flexural strength of an analogous article printed with a starch/cellulose-based powder (ZP-11). Moreover, significantly higher post-cure flexural strength values were measured in articles made from powders comprising a crosslinkable agent, as compared to articles made from ordinary starch/cellulose or plaster-based powders (ZP-11 and ZP-100, respectively).

### EXAMPLE 3

### Powder Compositions Comprising Strengthening Component

Powder formulations having the compositions set forth in Table 3 were prepared substantially as set forth in Example 1. Test bars were printed with each powder formulation substantially in accordance with the procedures set forth in Example 2, using standard aqueous binder ZB-7 (Z Corporation). The bars were heat cured for 45 minutes at 50° C., 120° C., and 180° C. and tested for flexural strength substantially in accordance with the procedure set forth in Example 2. The results are given in Table 4.

Printing resolution was gauged with test bars having a graded collection of 16 circular holes, arranged in two rows in ascending increments of surface/volume ratio. The “cake bars” measure 14 mm wide by 44 mm long by 5.7 mm thick, and were printed substantially as described in Example 2. The cake bars were cured under normal conditions, and de-powdered in conventional fashion. The strength of the caked (i.e. unreacted) material remaining inside the holes is evaluated in the following manner. The number of holes that can be “blown out” (i.e. substantially cleared of caked material) by an airstream of 40 psi through a 16-gauge needle for 5 minutes is taken as a “score”, and can be compared to results from other materials using the same test. The smaller holes are more difficult to clear, so as printing resolution improves, more and more small holes will be clearable. It is preferred that the air stream substantially clear 8 holes having a diameter of less than or equal to about 2 mm. The printing resolution results are provided in Table 4.

TABLE 3
Powder Formulations (given as percentage by weight)

| | N | O | P |
|---|---|---|---|
| LMB6199^{a} | 20 | 40 | 60 |
| Formulation H^{b} | | | 40 |
| ZP 100^{c} | 80 | 60 | |

^{a}an epoxy and carboxyl group-containing polyester composite powder from Vantico Ltd. (Duxford, UK)
^{b}a melamine-formaldehyde composition as given in Table 1
^{c}plaster-based powder from Z Corporation

TABLE 4
Flexural Strength and Holes Cleared

| Powder | Temperature | Flexural Strength/ | Print Resolution/ |
|---|---|---|---|
| Formulation | of Cure/(° C.) | Mpa | Holes Cleared |
| N | 50 | 1.1 | 14 |
| N | 120 | 2.3 | 14 |
| N | 180 | 3.7 | 14 |
| O | 50 | 1.2 | 13 |
| O | 120 | 2.8 | 13 |
| O | 180 | 5.1 | 13 |
| P | 0 | 5 | 5 |
| P | 50 | 6.5 | 5 |
| P | 120 | 8.9 | 5 |
| P | 180 | 13.7 | 5 |
| ZP 100 | 50 | 2.0 | 15 |
| ZP 100 | 120 | 2.1 | 15 |

Test bars made from Formulations N and O, which are plaster powders (ZP 100) containing a strengthening component (LMB 6199), and cured at temperatures above 50° C. (the melting point of the strengthening component) showed an increase in flexural strength as compared to unmodified ZP 100, without a significant effect on the number of holes cleared. At the lower cure temperatures (50° C.), Samples N and O are weak compared to ZP 100 alone, which demonstrates that the melting and curing of the strengthening component significantly strengthens the 3D article. Formulation P, which contained a crosslinkable agent (melamine-formaldehyde) and a strengthening component (LMB 6199), demonstrated significantly higher as-printed flexural strength, as well as post-cure flexural strength.

### EXAMPLE 4

### Powder/Binder Systems Comprising a Crosslinkable Agent and a Redox Couple

Powder systems having the compositions set forth in Table 5 were prepared substantially as set forth in Example 1. The ammonium persulfate and boric acid were ground to below 250 microns with a pin mill. Test bars and cake bars were printed from each of the powder systems substantially according to the procedure described in Examples 2 and 3.

The aqueous binder used for Samples A-D contained a reductant, and had the following composition: 83.42% deionized water; 7.89% sodium sulfite; 7.37% glycerol; 1.05% ethyl acetoacetate; 0.27% ethyl butyrate (all additives supplied by Aldrich Chemical Co., Milwaukee, Wis.). The binder for Sample E (absent a reductant) contained 91.30% deionized water; 7.37% glycerol; 1.05% ethyl acetoacetate; 0.27% ethyl butyrate; and 0.01% Iron (II) sulfate heptahydrate.

The test bars were printed at a saturation of either 4-1.25-1.25 (“low binder saturation”) or at 4-2-2 (“high binder saturation”). The layer thickness was 0.004 inches. The bars were tested for post-cure flexural strength and print resolution substantially according to the procedures set forth in Examples 2 and 3. The results are given in Tables 6 and 7.

TABLE 5
Powder Compositions

| | A | B | C | D | E |
|---|---|---|---|---|---|
| Filler | | | | | |
| SPHERIGLASS ® | 19.34 | 19.34 | 19.34 | 21.24 | 19.34 |
| 3000NC^{a} | | | | | |
| Adhesives | | | | | |
| ZP-14^{b} | 23.89 | 23.89 | 23.89 | 23.89 | 21.69 |
| AIRVOL ® 502^{c} | 6.9 | 6.9 | 6.9 | 6.9 | 6.9 |
| AQUAZOL ® 50^{d} | 3.8 | 3.8 | 3.8 | 3.8 | 3.8 |
| Crosslinkable Agent | | | | | |
| MF-817^{e} | 34.2 | 34.2 | 34.2 | 34.2 | 34.2 |
| Additives | | | | | |
| SPAN 85^{f} | 0.29 | 0.29 | 0.29 | 0.29 | 0.29 |
| LODYNE ® S-222N^{g} | 0.67 | 0.67 | 0.67 | 0.67 | 0.67 |
| CARBOPOL ® EZ-2^{h} | 1.51 | 1.51 | 1.51 | 1.51 | 1.51 |
| UOP T Pulverⁱ | 7.5 | 7.5 | 7.5 | 7.5 | 7.5 |
| Catalyst | | | | | |
| Ammonium Persulfate | 1.9 | | | | 1.9 |
| Boric Acid | | 1.9 | | | |
| Aluminum Chloride | | | 1.9 | | |
| Sodium Hydrogen Sulfite | | | | | 2.2 |
| Total | 100.0 | 100.0 | 100.0 | 100.0 | 100.0 |

^{a}Uncoated glass spheres from Potters Industries, Inc. (Valley Forge, PA)
^{b}Starch-based 3D printable powder from Z Corporation (Burlington, MA)
^{c}Polyvinyl alcohol from Schenectady International, Inc. (Schenectady, NY) (also known as Celvol 502 from Celanese Chemical Co., Frankfurt am Main, Germany)
^{d}Poly(ethyloxazoline) from Polymer Chemistry Innovations, Inc. (Tucson, AZ)
^{e}Powdered melamine/formaldehyde resin from BTSLR (Toledo, OH)
^{f}Sorbitan trioleate from Aldrich Chemical Co. (Milwaukee, WI)
^{g}Perfluoroalkyl polyether from Ciba Specialty Chemicals, Inc. (Tarrytown, NY)
^{h}Polyacrylic acid from Noveon, Inc. (Cleveland, OH)
ⁱZeolite from UOP LLC (Chicago, IL)

TABLE 6
Flexural Strength - High Binder Saturation
Thermal Cure Temperature/Time

| | | | |
|---|---|---|---|
| None | 120° C./30 min | 120° C./60 min | 160° C./10 min |

| | |
|---|---|
| Flexural Strength (MPa) | Holes Cleared |

| | | | | | |
|---|---|---|---|---|---|
| A | 2.74 | 16.46 | 15.47 | 19.60 | 3 |
| B | 5.49 | 19.16 | 18.64 | 19.05 | 0 |
| C | 5.77 | 22.21 | 20.66 | 21.17 | 0 |
| D | 3.28 | 20.43 | 19.80 | 23.53 | 0 |
| E | 6.01 | 18.70 | 19.31 | 20.72 | 5 |

^{a}Aldrich Chemical Co. (Milwaukee, WI)

TABLE 7
Flexural Strength - Low Binder Saturation
Thermal Cure Temperature/Time

| | | | |
|---|---|---|---|
| None | 120° C./30 min | 120° C./60 min | 160° C./10 min |

| | |
|---|---|
| Flexural Strength (MPa) | Holes Cleared |

| | | | | | |
|---|---|---|---|---|---|
| A | 1.36 | 8.12 | 11.51 | 11.80 | 5 |
| B | 1.53 | 7.86 | 8.81 | 12.73 | 4 |
| C | 1.62 | 12.76 | 12.23 | 10.91 | 1 |
| D | 1.25 | 6.12 | 12.32 | 14.61 | 0 |
| E | 4.25 | 12.88 | 12.95 | 13.96 | 7 |

Highly saturating the powder with binder substantially increased the flexural strength of the bars as compared to the low saturation bars (Table 6 vs. Table 7). But the printing resolution showed a corresponding decrease, with three of the systems providing bars with powder filling all holes (Table 7). Of the high saturation systems, only System E, which comprised an oxidant and a reductant together in the powder, provided bars having five clearable holes. Of the low saturation systems, only the all powder oxidant/reductant system E provided bars having seven clearable holes. The results indicate that the oxidant/reductant system provides faster curing of the crosslinkable agent, particularly as compared to the system without an acid catalyst of any kind (System D).

### EXAMPLE 5

### Powder/Binder System with Crosslinkable Polymer, Strengthening Component, Polyol and Redox Acid Generators

A powder system having the following formulation was mixed according to the protocol set forth in Example 1: 85.8% by weight of Powder X; 11.2% by weight of tetramethylol methane; 0.4% by weight polyacrylic acid (CARBOPOL® EZ-2); and 2.6% by weight ammonium persulfate.

Powder X was prepared as follows: a) 10 parts glycerol propoxylate triglycidyl ether (GPtGE) was mixed with 200 parts glass spheres (Spheriglass-3000A), then heated at 80° C. for two hours; b) gradually, melamine/formaldehyde resin (MF-817) (20 micron average particle size) was added up to 90 grams while mixing, after which the mixture was packed and heated at 66° C. for overnight; c) the mixture (a very brittle solid) was crushed into small pieces and machine ground into about 100 micron particles so that the powder could flow freely.

The aqueous binder composition was 8% by weight sodium sulfite; less than 0.01% by weight perfluoroalkyl polyether (LODYNE S-222N); and 92% by weight de-ionized water.

In order to assess green strength development, test bars were printed from the material system described above according to the protocol in Example 2 (with the exception that in this Example 5, the bars were air-dried, not oven-dried). The bars were de-powdered and air-dried at room temperature for a variety of intervals ranging from 1.25 to 7.4 hours after build. Flexural strength values were measured and reported as follows:

| | | | | | |
|---|---|---|---|---|---|
| Time after Build (in hours): | 1.25 | 2.2 | 4.2 | 5.4 | 7.4 |
| Flexural Strength (MPa): | 0.14 | 0.32 | 1.9 | 3.2 | 5.1 |

The test bars were then subjected to a thermal cure and tested for flexural strength according to the protocol set forth in Example 2. The results were reported as follows:

| Thermal Cure | Flexural Strength |
|---|---|
| 80° C. for 1 hour, then 165° C. for 0.5 hour: | 14 MPa (Y-axis) |
| 80° C. for 1 hour, then 130° C. for 0.5 hour: | 9 MPa (Y-axis) |

### EXAMPLE 6

### Compositions with Polyol, Strengthening Component and Redox Acid Generators

A powder system having the following composition was mixed according to the protocol set forth in Example 1: 84.0% by weight of Powder X (as described in the preceding Example); 11.0% by weight of tetramethylol methane; 0.8% by weight of polyacrylic acid (CARBOPOL® EZ-2); and 4.2% by weight ammonium persulfate.

The aqueous binder composition was 8% by weight sodium sulfite; 5% by weight 1,3,5-trisethylol cyanuric acid; less than 0.01% by weight perfluoroalkyl polyether (LODYNE S-222N); and by weight 77% water.

In order to assess green strength development, test bars were printed from the material system described above according to the protocol in Example 2. The bars were de-powdered and air-dried at room temperature for a variety of intervals ranging from 1.48 hours to 5.5 hours after build. Flexural strength values were measured and reported as follows:

| | | | | | |
|---|---|---|---|---|---|
| Time after Build (in hours): | 1.48 | 2 | 2.5 | 4.6 | 5.5 |
| Flexural Strength (MPa): | 0.59 | 1.08 | 1.53 | 2.15 | 2.85 |

### EXAMPLE 7

### Powder/Binder Systems Comprising a Redox Couple and a Filler Coated with Crosslinkable Agent

| Thermal Cure | Flexural Strength |
|---|---|
| 80° C. for 1 hour, then 165° C. for 0.5 hour: | 14 MPa (Y-axis) |
| 80° C. for 1 hour, then 130° C. for 0.5 hour: | 9 MPa (Y-axis) |

500 grams of Spheriglass 3000 NC (uncoated glass spheres) was mixed with 50 grams of CYMEL® 303 (hexamethoxymelamine from Cytec industries Inc., West Paterson ,N.J.) and dried in an oven at 40 degrees for 8 hours. The mixture (a very brittle solid) was crushed into small pieces and machine ground into about 100 micron particles so that the powder could flow freely (hereinafter “Powder Z”).

A powder system having the following formulation was mixed according to the protocol set forth in Example 1: 50 grams by weight of Powder Z; 23.89 grams of ZP-14 (Z Corporation); 10.7 grams AIRVOL 502; 3.54 grams MF-817; 0.29 grams SPAN 85; 0.67 grams LODYNE S-222N; 1.51 grams CARBOPOL EZ-2; 7.5 grams UOP T Pulver; and 1.9 grams ammonium persulfate.

The aqueous binder composition was 8% by weight sodium sulfite; 0.1% by weight LODYNE S-222N; 0.5% ethylbutyrate and 0.4% ethylacetoactate (both from Aldrich Chemical Co.), and 91% by weight deionised water

In order to assess green strength development, test bars were printed from the materials system described above according to Example 2.

| | | |
|---|---|---|
| Time from build (hours) | 0.5 | 1.5 |
| Flexural strength (MPa) | 1.5 | 1.5 |

This example shows that green strength developed quickly.

### EXAMPLE 8

### Powder/Binder System Comprising a Crosslinkable Agent and a Blocked Acid Catalyst

A powder system having the following formulation was mixed according to the protocol set forth in Example 1: 21.24% by weight Spheriglass 3000 NC; 23.89% by weight ZP-14; 10.7% by weight AIRVOL 502; 34.2% by weight MF-817; 0.29% by weight SPAN 85; 0.67% LODYNE S-222N; 1.51% CARBOPOL EZ-2; and 7.5% UOP T Pulver

The aqueous binder was 98.1% by weight ZB-4; and 1.9% Nacure XP-386.

In order to assess strength development, test bars were printed at low binder saturation from the material system, described above and cured at 80° C.

| | | | |
|---|---|---|---|
| Cure time (minutes) | 0 | 15 | 30 |
| Flexural strength (MPa) | 3.28 | 5.91 | 7.7 |

The example shows that a blocked acid can be incorporated into the binder without hindering its performance, and that a blocked acid catalyzes the crosslinking at a lower cure temperature than is usually required.

We claim:

1. A powder system for use in a three-dimensional printer with an aqueous binder, said powder system comprising a water-soluble crosslinkable agent.

2. The powder system of claim 1, wherein the crosslinkable agent is selected from the group consisting of amino resins, phenol resins, and mixed amino/phenol resins.

3. The powder system of claim 1, wherein the crosslinkable agent is selected from the group consisting of melamine-formaldehyde resins, urea-formaldehyde resins, melamine-urea-formaldehyde resins, melamine-phenol-formaldehyde resins, benzoguanamine-formaldehyde resins, glycoluril-formaldehyde resins and acetoguanamine-formaldehyde resins.

4. The powder system of claim 1, wherein the crosslinkable agent is a glyoxal resin or a methyol carbamate.

5. The powder system of claim 1, wherein at least some of the crosslinkable agent is present in the system as a film coating on filler material.

6. The powder system of claim 5, wherein the filler material is glass spheres, flakes or fiber.

7. The powder system of claim 1, wherein the crosslinkable agent is present in an amount from about 10% to about 60% by weight of the total weight of the powder system.

8. The powder system of claim 1, further comprising a polyol.

9. The powder system of claim 1, further comprising a blocked acid catalyst.

10. A powder system for use in a three-dimensional printer with an aqueous binder, said powder system comprising a strengthening component that melts and flows upon heating, then cures, or resolidifies upon cooling.

11. The powder system of claim 10, wherein the strengthening component is a thermosettable polymer.

12. The powder system of claim 11, wherein the strengthening component is a blend of an epoxy and a carboxy group-containing water-soluble a crosslinkable polymer.

13. The powder system of claim 1, further comprising a strengthening component that melts and flows upon heating, then cures, or resolidifies upon cooling.

14. A powder system for use in a three-dimensional system with an aqueous binder, said powder system being acid sensitive, and comprising a redox pair, or one half of a redox pair.

15. The powder system of claim 14, wherein the one half of a redox pair is an oxidant.

16. The powder system of claim 14, wherein the one half of a redox pair is a reductant.

17. The powder system of claim 14, further comprising a catalyst for the redox pair.

18. The powder system of claim 1, further comprising a redox pair, or one half of a redox pair.

19. The powder system of claim 18, further comprising a strengthening component.

20. The powder system of claim 10, further comprising a redox pair, or one half of a redox pair.

21. A 3D article printed on a three-dimensional printer from a powder system and an aqueous binder system, wherein said powder system comprises a crosslinkable agent, and the article has an as-printed flexural strength of greater than 10 MPa.

22. The 3D article of claim 21, wherein the article has an as-printed flexural strength of greater than 20 MPa.

23. A 3D article printed on a three-dimensional printer from a powder system and an aqueous binder system, wherein the 3D article has a flexural strength after thermal cure of at least about 20 MPa.

24. The 3D article of claim 23, wherein the article has a flexural strength after thermal cure of at least about 30 MPa.

25. The 3D article of claim 24, wherein the article has a flexural strength after thermal cure of at least about 40 MPa.

26. The 3D article of claim 25, wherein the article has a flexural strength after thermal cure of at least about 50 MPa.

27. A 3D article printed on a three-dimensional printer from a powder system and an aqueous binder system, wherein the powder system comprises a conventional starch/cellulose or plaster powder and a strengthening component, and wherein the 3D article has a flexural strength after thermal cure of at least about 2.25 MPa.

28. The 3D article of claim 27, wherein the 3D article has a flexural strength after thermal cure of at least about 2.75 MPa.

29. The 3D article of claim 28, wherein the 3D article has a flexural strength after thermal cure of at least about 3.5 MPa.

30. The 3D article of claim 29, wherein the 3D article has a flexural strength after thermal cure of at least about 5.0 MPa.

31. A 3D article printed on a three-dimensional printer from a powder system and an aqueous binder system, wherein the powder system comprises starch/cellulose or plaster powder and a strengthening component, and wherein the 3D article has a flexural strength after thermal cure that is at least about 20% higher than the flexural strength of a similar article created and cured under the same conditions using a starch/cellulose or plaster powder that does not contain a strengthening component.

32. The 3D article of claim 31, wherein the 3D article has a flexural strength after thermal cure that is at least about 50% higher than the flexural strength of a similar article created and cured under the same conditions using a starch/cellulose or plaster powder that does not contain a strengthening component.

33. A 3D article printed on a three-dimensional printer from a powder system and an aqueous binder system, wherein the powder system comprises a crosslinkable agent and a strengthening component, and wherein the 3D article after thermal cure is at least about four times stronger than a similar article made from a starch/cellulose or plaster powder having no crosslinkable agent or strengthening component.

34. A method of printing a 3D article in a 3D printer, the steps comprising
a) using the powder system of claim 1 to form a powder layer;
b) dispersing onto the powder layer an aqueous binder fluid in a predetermined pattern;
c) permitting the fluidized layer to at least partially solidify;
d) repeating steps a) through c) until the 3D article achieves its final shape.
